(19) United States
(12) Patent Application Publication
(10) Pub. No.: US 2021/0189982 A1
(43) Pub. Date: Jun. 24, 2021

(54) Powertrain with Continuously Variable Transmission and Aftertreatment System

(71) Applicant: Caterpillar Inc., Peoria, IL (US)

(72) Inventors: Kevin J. Weiss, Peoria, IL (US); Paul R. Moore, Dunlap, IL (US)

(73) Assignee: Caterpillar Inc., Peoria, IL (US)

(21) Appl. No.: 16/721,087

(22) Filed: Dec. 19, 2019

(51) Int. Cl. F02D 41/02; B60W 30/00; B60W 10/06; B60W 10/101; F16H 47/08; B60W 10/30; F01N 3/20

(52) U.S. Cl. CPC F02D 41/0235; B60Y 2300/474; B60W 10/06; B60W 10/101; F16H 47/08; B60W 10/30; F01N 3/2006; F01N 3/2066; B60W 2710/0644; B60W 2710/1038; B60W 2530/12; B60W 2510/0638; B60W 2710/0616; B60W 2710/30; B60W 2710/105; B60W 30/00

(57) ABSTRACT

A powertrain for a machine includes an internal combustion engine, an aftertreatment system including a selective catalytic reduction (SCR) catalyst for treating exhaust gases from the internal combustion engine, and a continuously variable transmission operatively coupled to the internal combustion engine. An electronic controller can measure a catalyst temperature of the SCR catalyst and can inversely adjust an engine speed and a CVT output to selectively regulate a catalyst temperature of the SCR catalyst. In an embodiment, the CVT may be a hydro-mechanical transmission including a hydrostatic transmission and a mechanical transmission.

### TECHNICAL FIELD

This patent disclosure relates generally to operation of a powertrain including an internal combustion engine and a continuously variable transmission and, more particularly, to a system and method of the engine and CVT to regulate an aftertreament system.

### BACKGROUND

Powertrains are the assemblies that transmit the rotational power produced by an internal combustion engine to the point of application or load. Powertrains may include various components and devices to manipulate and adjust the rotational power being transmitted, for example, by changing the angular direction, the torque, or the rotational speed. Transmissions are a major component of a powertrain in which the rotational speed and, inversely, the torque can be changed from input to output. Traditional transmissions typically increased or reduced speed through a series of fixed gear ratios, however, continuously variable transmissions (CVTs) have been developed that enable speed and torque to be adjusted through a continuous range of input rotation to output rotation. Because of the adaptability associated with CVTs, they have been used in heavy industrial applications and large scale mobile machines for construction, mining, agriculture, and other industries

Also included in powertrains are internal combustion engines, which may be operatively associated with emission control technologies such as aftertreatment systems that function by reducing or converting emissions produced by the internal combustion process. One example of an aftertreatment system is selectively catalytic reduction (SCR) in which the exhaust gases are chemically reacted in the presence of a catalyst with an introduced reductant fluid to convert nitrogen oxides (NOₓ) to nitrogen (N₂) and water (H₂O). Aftertreatment system have also been operated in conjunction with the powertrain to achieve advantageous results in power generation. For example, U.S. Pat. No. 8,073,610 (“the '610 patent”) describes a system in which a transmission and an aftertreatment catalyst may be used together to improve operative efficiency of the system. However, as the operative state or output of the internal combustion engine changes, it may affect the aftertreatment process. The present disclosure is directed to novel systems and methods for cooperatively operating an aftertreatment system in combination with a powertrain including a CVT.

### SUMMARY

The disclosure describes, in an aspect, a drivetrain including an internal combustion engine with a plurality of combustion chambers in which to combust a fuel. An exhaust system may be in fluid communication with the plurality of combustion chambers to direct exhaust gases away from the internal combustion engine. Disposed in the exhaust system can be a selective catalytic reduction (SCR) catalyst to reduce nitrogen oxides (NOₓ) in the exhaust gases to nitrogen (N₂) and water (H₂O). The internal combustion engine can be operatively associated with a continuously variable transmission (CVT) coupled to a driveshaft. An electronic controller may also be associated with the internal combustion engine and with the CVT to inversely adjust the engine speed and a CVT output to selectively regulate a catalyst temperature of the SCR catalyst.

In another aspect, the disclosure describes a method of operating a powertrain to regulate temperature of a selective catalytic reduction (SCR) catalyst. The method measures a catalyst temperature of the SCR catalyst disposed in an exhaust system of an internal combustion engine and regulates the engine speed of the engine in an inverse relation to the catalyst temperature. The method also regulates a CVT output of a continuously variable transmission (CVT) coupled to the internal combustion engine in a direct relation to the catalyst temperature to offset the adjustment to engine speed.

In yet another aspect, the disclosure describes a powertrain including an internal combustion engine with a plurality of combustion chambers in which the combustion of fuel occurs. An exhaust system communicates with the plurality of combustion chambers to remove the exhaust gases. To reduce nitrogen oxides (NOₓ) in the exhaust gases to nitrogen (N₂) and water (H₂O), a selective catalytic reduction (SCR) catalyst is disposed in the exhaust system. Coupled to the driveshaft of the internal combustion engine is a continuously variable transmission operatively (CVT) for adjusting speed and/or torque in the powertrain. A electronic controller associated with the powertrain is configured to receive and compare the catalyst temperature to a catalytic threshold. If the catalyst temperature is below the catalytic threshold, the electronic controller increases the engine speed and restricts a CVT output to warmup the SCR catalyst.

### BRIEF DESCRIPTION OF THE DRAWINGS

FIG. 1 is a block diagram of a powertrain including an internal combustion engine operatively associated with a continuously variable transmission and with an aftertreatment system.

FIG. 2 is a schematic representation of a chart illustrating a variable range of related operating conditions of the internal combustion engine and the continuously variable transmission in accordance with the disclosure.

FIG. 3 is a flow diagram illustrating an example of a computer implemented methodology or process for regulating the catalyst temperature of an aftertreatment catalyst through selective operation of the internal combustion engine and the continuously variable transmission.

### DETAILED DESCRIPTION

Now referring to the drawings, wherein whenever possible like elements refer to like reference numbers, there is illustrated a powertrain 100 for transmission of rotational power produced by an internal combustion engine 102 to a point of application or a load 104 such as a propulsion device. The internal combustion engine 100 is configured to combust a mixture of an oxidizer such as air and a hydrocarbon-based fuel to convert the chemical energy therein to a motive mechanical power in the form of rotational motion that can be applied through a driveshaft 1-106 of the engine for other work. The internal combustion engine 100 may be any size, but the present application is particularly suited to large-scale heavy industrial engines on the magnitude of several hundred horsepower or kilowatts. Internal combustion engines of these scales are used in a variety of industrial machines including mobile machines used in construction, mining, agriculture, and other industries such as wheel loaders, dozers, dumb trucks, and the like. Moreover, while the internal combustion engine 102 can combust any suitable fuel and can operate on any suitable combustion cycle, the present disclosure may be particularly applicable to diesel burning, compression-ignition engines.

To deliver fuel for the combustion process, the internal combustion engine 102 can be operatively associated with a fuel system 110. The fuel system 110 may include a plurality of fuel injectors 112 that are operatively disposed to deliver fuel to a respective plurality of combustion chambers in the internal combustion engine 102, with at least one fuel injector associated with each combustion chamber. The fuel injectors 112 can inject a desired quantity of fuel into the combustion chamber where it is ignited and the resulting combustion reciprocally drives a piston attached to and rotating a crankshaft. In diesel-burning compression ignition engines, the fuel auto-ignites upon introduction to the highly pressurized conditions in the cylinder 104 resulting from the compression stroke, and accordingly, the fuel injectors 112 may be timed to increase efficiency and power generation. To store the fuel, the fuel system 110 can include a fuel reservoir or fuel tank 114 that is in fluid communication with the plurality of fuel injectors 112 through one or more fuels lines 114, which may also be associated with fuel pumps, fuel rails and the like.

To deliver air for use as an oxidizer in the combustion process, the internal combustion engine 102 can be operatively associated with an air intake system 120. The air intake system 120 can receive air from the surrounding environment, which may be the atmosphere, through an air filter 122 to remove contaminants, dust, and debris. The intake air is delivered from the air filter 122 through an intake conduit 124 to an intake manifold 126 on the internal combustion engine 102. The intake manifold 126 is in fluid communication with and can direct the intake air to the plurality of combustion chambers. The intake air can be selectively admitted to the combustion chambers through the selective actuation of one or more intake valves associated with each chamber.

To remove the byproducts of the combustion process from the combustion chambers, the internal combustion engine 102 can be operatively associated with an exhaust system 130. The exhaust system 130 can include an exhaust manifold 132 included with the internal combustion engine 102 and in fluid communication with the plurality of combustion cylinders via selectively actuated exhaust valves. As the piston disposed in the combustion chamber reciprocally moves upwards with the exhaust valve open, the exhaust gases are forcibly discharged to the exhaust manifold and can be directed by an exhaust conduit 134 to the atmosphere.

In an embodiment, to increase the efficiency of the internal combustion engine 102, a turbocharger 140 can be operatively associated with the intake system 120 and the exhaust system 130. The turbocharger 140 can include a turbine 142 disposed in the exhaust conduit 134 that is coupled to a compressor 144 disposed in the intake conduit 124. The turbine 142 and the compressor 144 can each include a plurality of appropriately shaped vanes that are attached to a rotating hub 146 coupling the turbine and compressor. As pressurized exhaust gases are directed through and expand in the turbine 142 past the vanes, the pressurized flow may drive the rotating hub 146 which in turn rotates the vanes in the compressor 144. The compressor 144 therefore compresses the intake air increasing the flow delivered to the internal combustion engine 102.

To treat emissions in the exhaust gases, the internal combustion engine 102 can be operatively associated with an aftertreatment system 150 including one or more aftertreatment devices disposed in the exhaust conduit 134 downstream of the engine. For example, to reduce nitrogen oxides like NO and NO₂, sometime referred to as NOR, the aftertreatment system 150 can conduct a selective catalytic reduction (SCR) process in which the NOx in the exhaust gases is converted to nitrogen (N₂) and water (H₂O). In the SCR process, the exhaust gases are directed through an SCR catalyst 152 disposed in the exhaust conduit 134 and interact with a reductant agent, referred to as diesel exhaust fluid (DEF), with a common DEF being urea. The DEF may include ammonia (NH₃), which in the presence of the SCR catalyst 152 reacts with the NOₓ converting it to Na and H₂O. To deliver DEF to the exhaust gases, a DEF injector 154 may be in fluid communication with the exhaust conduit 134 upstream of the SCR catalyst 152, although it may possibly be disposed directly into the SCR catalyst 152. The DEF injector 154 can be an electromechanically operated injector configured to introduce measured amounts of pressurized DEF as a spray into the exhaust conduit 134 in a process sometimes referred to as dosing. The DEF itself may be retained in a refillable DEF tank 156 or reservoir on the machine associated with the internal combustion engine 102.

In addition to the SCR catalyst 152, the aftertreatment system 150 can include other devices to treat the exhaust gasses. For example, to reduce carbon monoxide (CO) and hydrocarbons (CₓHₓ) attributable to unburned fuel in the exhaust gases, a diesel oxidation catalyst (DOC) 158 can be disposed in the exhaust conduit 134 to initiate an oxidation reaction converting those components to carbon dioxide (CO₂) and water (H₂O). As another example, to remove particulate matter and soot from the exhaust gases, a diesel particulate filter (DPF) may be disposed to receive and filter the exhaust flow. Because the filter physically traps and accumulates particulate matter, it may require periodic regeneration or cleaning before its starts to impede exhaust flow.

In addition to the internal combustion engine 102 and its support systems, the powertrain 100 can also include a transmission 160 to change the rotational speed and, in an inverse relation, the torque being produced by the engine. The transmission 160 can be operatively coupled to the driveshaft 106 projecting from the internal combustion engine 102 and directly receives the rotational motion therefrom. In an embodiment, the transmission 160 may be a continuously variable transmission (CVT) configured to operate over a continuous range of input speed and torque to output speed and torque rather than stepping through fixed gear ratios. In a more particular embodiment, the CVT 160 may be a split torque hydro-mechanical transmission in which the rotational motion and torque from the internal combustion engine 102 is transmitted through a hydrostatic transmission 162 and a mechanical transmission 164. The hydrostatic transmission 162 can receive rotational power through an input 166 to the CVT 160, that is used to drive a variable displacement pump 170. The hydrostatic transmission 162 can also include a variable displacement motor 172 in fluid communication with the variable displacement pump 170 through a hydrostatic fluid circuit 174. The variable displacement pump 170 and motor 172 can be variably adjusted to alter the pressures and flowrates in the fluid circuit so that turns or strokes of the pump can drive quantitatively different turns or strokes that result in the motor.

The mechanical transmission 164 can also be directly coupled to the input 166 of the CVT 160, thus splitting the torque input, and can have any suitable configuration including a plurality of adjustably intermeshable gears. In a particular embodiment, the mechanical transmission 164 can include one or more planetary gear sets 180. The planetary gear set 180 may include a central sun gear 182 surrounded by one or more revolving planet gears 184 that can move around the sun gear 182. The planet gears 184 mesh with and are surrounded by a ring gear 186. By selectively restricting or releasing one set of gears of the planetary gear set 180, the other sets of gears can be made to rotate or revolve in varying speeds and directions. The outputs of the hydrostatic transmission 162 and the mechanical transmission 164 can be combined and directed through an output 168 of the CVT 160 and transmitted onto the load 104. In addition to the hydrostatic transmission 162 and mechanical transmission 164, the CVT 160 can include other gears, clutches and the like to facilitate transmission and adjustment of rotational power from the input 166 to the output 168.

To coordinate and regulate operation of the powertrain 100, an electronic controller 190 can be included, which may also be referred to as an electronic control unit (ECU), or as an engine control module (ECM), or possibly just controller. The electronic controller 190 can be a programmable computing device and can include one or more microprocessors 192, non-transitory computer readable and/or writeable memory 193 or a similar storage medium, input/output interfaces 194, and other appropriate circuitry for processing computer executable instructions, programs, applications, and data to regulate performance of the powertrain 100. The electronic controller 190 may be configured to process digital data in the form of binary bits and bytes. The electronic controller 190 can communicate with various sensors to receive data about powertrain operation and performance characteristics and can responsively control various actuators to adjust that operation.

To send and receive electronic signals to input data and output commands, the electronic controller 190 can be operatively associated with a communication network having a plurality of terminal nodes connected by data links or communication channels. For example, as will be familiar to those of skill in the art of automotive technologies, a controller area network (“CAN”) can be utilized that is a standardized communication bus including physical communication channels conducting signals conveying information between the electronic controller 190 and the sensors and actuators. However, in possible embodiments, the electronic controller 190 may utilize other forms of data communication such as radio frequency waves like Wi-Fi, optical wave guides and fiber optics, or other technologies. In an embodiment, the electronic controller 190 may be a preprogrammed, dedicated device like an application specific integrated circuit (ASIC) or field programmable gate array (FPGA). To possibly interface with an operator or technician, the electronic controller 190 can be operatively associated with an operator interface display that may be referred to as a human-machine interface (HMI).

In an embodiment, the electronic controller 190 can responsively regulate operation of the powertrain 100 such that the internal combustion engine 102, the aftertreatment system 150, and the CVT 160 cooperatively interact together. Therefore, the electronic controller 190 can be operatively associated and in electrical communication with sensors, actuators and control devices associated with the three assemblies. For example, to control and adjust operation of the internal combustion engine 102, the electronic controller 190 can control devices thereon such as the plurality of fuel injectors 112. In addition, to determine the operating speed of the engine 102, the electronic controller 190 can be associated with an engine speed sensor 196. In an embodiment, the engine speed sensor 196 can be in physical contract with the driveshaft 106 to measure revolutions per minute (RPM), or can operate on magnetic or optical principles to sense the rotational speed of the driveshaft.

To control operation of the aftertreatment system 150 and, in particular, the SCR process, the electronic controller 190 can be associated with a SCR sensor 197 disposed proximate to the SCR catalyst 152. The SCR sensor 197 may measure variables and parameters related to the SCR process such as, for example, the temperature of the SCR catalyst 152. For the reaction of DEF with NOx to occur, the SCR catalyst 152 must be at an elevated temperature, for example, approximately 200° C. and higher, depending upon the catalytic materials and catalyst size. The SCR sensor 197 may also sense other properties important to the SCR process, such as NOx content of the exhaust gases. To determine the exhaust temperature and flowrate, the electronic controller 190 can be associated with an exhaust sensor 198 that may be disposed in or immediately downstream of the exhaust manifold 132. The flowrate of the exhaust gases can be measured in terms of volume, time, and/or pressure. To variable adjust the CVT 160 to change the ratio of speed and/or torque between the input 166 and the output 168, the electronic controller 190 can be associated with a CVT controller 199 that operatively adjusts the hydrostatic transmission 162 and the mechanical transmission 164.

In an embodiment, the electronic controller 190 can control operation of the powertrain 100 to regulate temperature of the SCR catalyst 152 as needed to conduct the SCR process. As stated above, the SCR catalyst 152 must be at elevated temperatures to convert NOₓto Na and H₂O, typically above 200° C. Such a temperature may be referred to as the activation temperature or catalytic threshold. Depending upon whether the SCR catalyst 152 is above or below the catalytic threshold, the electronic controller 190 may be programmed to implement and switch between a warmup mode and a keep warm mode. In the warmup mode, the SCR catalyst 152 may be below the catalytic threshold and the electronic controller 190 may operate the powertrain 100 to rapidly raise the catalyst temperate to the catalytic threshold. Warmup mode may be implemented when the internal combustion engine 100 is initially started or has been running in idle for a period of time. In keep warm mode, the SCR catalyst 152 may be at or above the catalytic threshold and the electronic controller 190 may operate the powertrain 100 to maintain that temperature. The aftertreatment system 150 may be designed and disposed with respect to the exhaust system 130 so that the keep warm mode may be implemented during normal or routine operating conditions of the internal combustion engine 102.

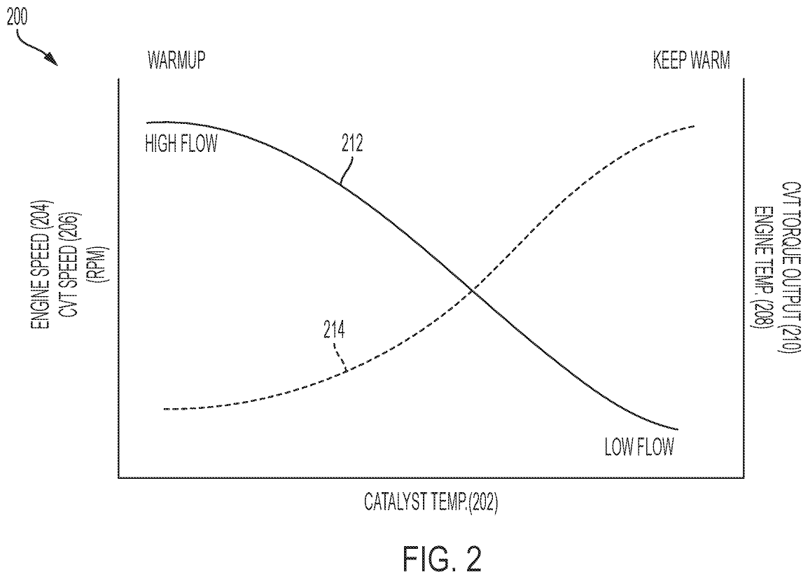

To implement and switch between the warmup mode and the keep warm mode while maintaining the prevailing operation and settings for the powertrain 100, the electronic controller 190 can adjust operation of the internal combustion engine 102 and the CVT 160 in a related and inverse manner. For example, referring to FIG. 2, the engine 102 and CVT 160 can be operated to maintain a set speed or torque desired of the powertrain 100 at the load 104 while utilizing the exhaust gases to regulate temperature of the SCR catalyst 152. FIG. 2 is an illustrative graph 200 depicting the relation between the catalyst temperature 202 along the X-axis, the engine speed 204 and CVT speed 206 in, for example, RPM on the left Y-axis, and the engine temperature 208 and CVT output torque 210 on the right Y-axis.

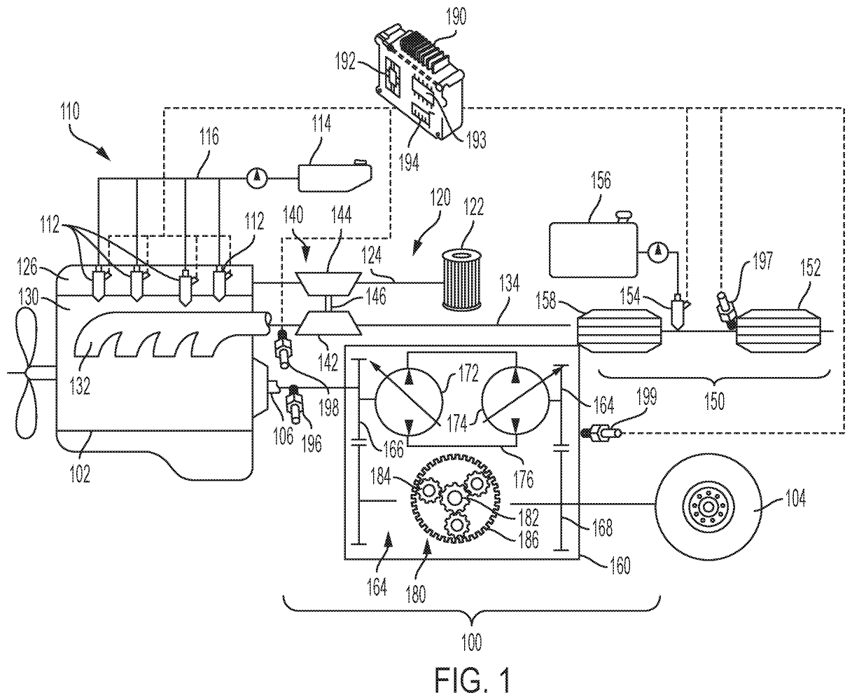

When the catalyst temperature 202 is low and insufficient to conduct the SCR process, the electronic controller 190 can increase the engine speed 204 which results in increasing the exhaust gases produced and thus the exhaust flowrate. In FIG. 2, the increase in engine speed 204 may be represented by the solid curve 212. The engine speed 204 may, for instance, be increased above a set or desired speed. In heavy duty or large scaled applications, the internal combustion engine 102 may be set at a constant speed and power output at or near its peak efficiency or peak power output and any desired variation in rotational speed and/or torque may be addressed by adjusting the transmission or similar assembly. However, in the warmup mode, to increase the flowrate of hot exhaust gases directed to the SCR catalyst 152, the engine speed 204 is increased resulting in more exhaust gases and an increased exhaust flowrate. This effectively increases the enthalpy or heat energy directed to the SCR catalyst 152 to rapidly increase or raise the catalyst temperature to the catalytic threshold. In a diesel combustion engine, engine speed 202 can be increased by increasing the quantity of fuel introduced to the combustion chambers per combustion cycle. In the embodiment of FIG. 1, the electronic controller 190 may direct the plurality of fuel injectors 112 accordingly to increase the fuel injection quantities. To adjust for or offset the increased engine speed 204, the electronic controller 190 can inversely adjust the CVT 160. In particular, the ratio of the CVT speed 206 between the CVT input 166 to the CVT output 168 can be decreased in an inverse proportion to the increase in engine speed 204. The inversely proportional decrease in CVT speed 206 can be represented by the location of the dashed curve 214 under the warmup mode. Accordingly, the overall speed output of the powertrain 100 remains constant.

As the SCR catalyst 152 rises in catalyst temperature 202 toward the catalytic threshold, the electronic controller 190 can switch to the keep warn mode in which it attempts to maintain the catalyst temperature 202. Accordingly, the engine speed 204 can be decreased to a desired or set speed, as indicated by the location of the solid curve 212 in the keep warm region. The decrease in engine speed 204 results in a decrease in exhaust flowrate to the SCR catalyst 152; however even the lower flowrate may be sufficient to maintain the catalyst temperature at or in excess of the catalytic threshold. Also, in diesel combustion engines, decreasing engine speed results in a decrease in the air/fuel ratio in the combustion chambers. A decrease in engine speed results in a decrease in intake air mass flow directed the combustion chamber, for example, due to a decrease in the efficiency of the turbocharger. Thus, although the decrease in engine speed is caused by decreasing the quantity of fuel introduced to the combustion chambers, the decrease in intake air mass flow occurs at a greater rate thereby resulting in an air/fuel ratio closer to stoichiometric and richer combustion conditions. Rich combustion conditions typically result in higher temperatures and result in hotter exhaust gases to maintain the catalyst temperature 202 of the SCR catalyst 152 above the catalytic threshold. To maintain constant powertrain output, the CVT speed 206 can be inversely increased as indicated by the location of the dashed curve in the keep warm region.

In an embodiment, as indicated by the solid and dashed curves 212, 214, the inverse adjustments between the engine speed 204 and CVT output 206 may be proportionally scaled and may occur across a range of catalyst temperatures 202 as a continuum or spectrum. Accordingly, the transition between warmup mode and keep warm mode may not be explicitly defined. Moreover, the electronic controller 190 may direct engine and CVT operation between the warmup or keep warm modes as a continuously responsive process to account for increases and decreases in the catalyst temperature 202. The engine speed sensor 196 can measure the instantaneous engine speed 204 which can be converted by the electronic controller 196 to the appropriate CVT speed 206 in a related but inverse relation so that the output of the powertrain remains consistent. Further, the electronic controller may attempt to balance between the warmup and keep warm modes for the instant catalyst and other conditions to optimally regulate the temperature of the SCR catalyst. It should be noted that FIG. 2 is exemplary only, and should not be construed as indicating specific values or direct relations between values of the internal combustion engine 102 or CVT 160.

### INDUSTRIAL APPLICABILITY

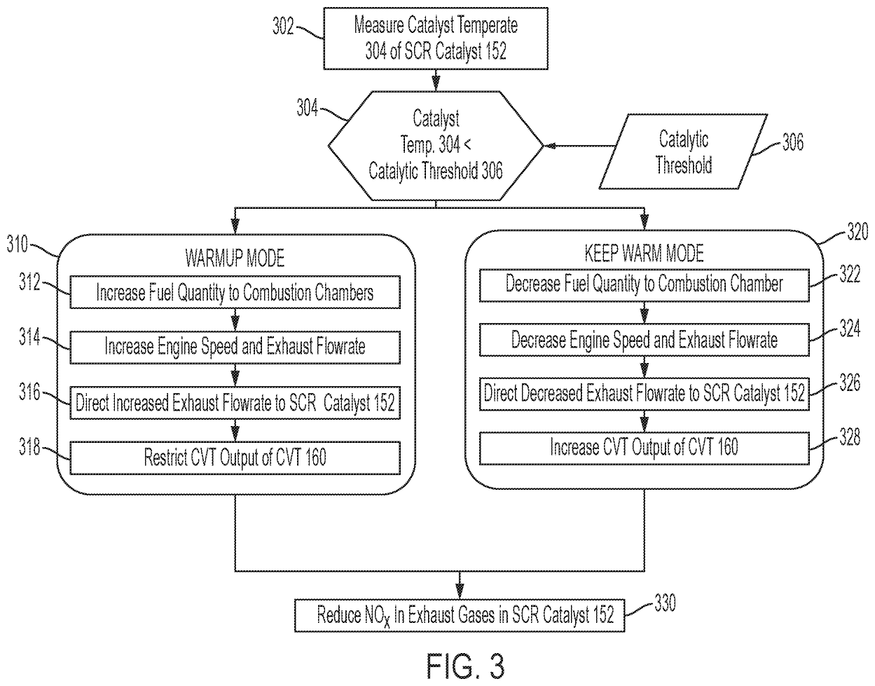

Referring to FIG. 3, there is illustrated a flow diagram 300 of an exemplary routine or algorithm for operating the disclosed powertrain 100. The flow diagram 300 can include a series of steps, including actions and decisions, that can be implemented as computer-executable software instructions or code in the form of an application or program that can be executed by the processor 192 associated with the electronic controller 190. Further, the flow diagram 300 in software form may be stored in a non-transitory state in the memory 193 associated with the electronic controller 190.

The process disclosed in the flow diagram 300 can be initiated with a measurement step 302 measuring the catalyst temperature 304 of the SCR catalyst 152. The measurement step 302 can be accomplished with the SCR sensor 197 operably associated with the SCR catalyst 152. In the embodiment of the flow diagram 300, the catalyst temperature 304 can be compared to a catalytic threshold 306 to determine if the SCR catalyst is at a catalyst temperature sufficient to conduct the SCR process. The catalytic threshold 306 can be determined in part by the material of the SCR catalyst, the size of the SCR catalyst, and other information such as exhaust flow rate and exhaust temperature and, for example, may be approximately 200° C., which may be the activation temperate of a typical SCR catalyst. In contrast to the procedure described above with respect to FIG. 2, where the relative speeds or outputs of the internal combustion engine 102 and CVT 160 are cooperatively adjusted over a continuum of catalyst temperatures 202, the flow diagram 300 represents a more decisive and binary determination of operating between the warmup and keep warm modes based on the catalytic threshold 306. The catalytic threshold 306 may be stored as electronic data in the memory 193 of the electronic controller 190.

In the event the catalyst temperature 304 is below the catalytic threshold 306, the flow diagram 300 may proceed to a warmup mode 310. The catalyst temperature 304 may be below the catalytic threshold 306 because the internal combustion engine 102 is just starting up or has been in idle. In large scale internal combustion engines 102 used on mobile machines associated with the mining industry or on industrial pumps and generators, the engines may be placed in idle for several hours to conserve fuel but enable the SCR catalyst 152 to cool below the catalytic threshold 306. In warmup mode, to rapidly increase the catalyst temperature 304, an increase fuel step 312 may be conducted to increase the fuel quantity introduce to the plurality of combustion chambers. In diesel combustion engines, this results in an increase in an engine speed/exhaust flowrate step 314. Particularly, increasing the fuel quantity accelerates the engine speed resulting in an increased exhaust flowrate discharged from the combustion chambers. In an exhaust direction step 316, the increased exhaust flowrate is directed to the SCR catalyst 152 to rapidly heat it to the catalytic threshold. In particular, because there is a significant volume of hot exhaust flow through the SCR catalyst 152, more enthalpy or heat energy is quickly transferred to the materials of the SCR catalyst than during lower engine speeds.

To compensate for the increased engine speed, which may be above a desired or commanded engine speed under which the internal combustion engine 102 is governed, the warmup mode 310 can in a restriction step 318 restrict the CVT output of the CVT 160. For example, the CVT 160 may decrease the CVT output speed relative to the CVT input speed by adjusting the hydrostatic transmission 162 and mechanical transmission 164. Accordingly, adjusting the CVT 160 compensates for the increased engine speed such that the output of the powertrain 100 remains consistent.

In the event the catalyst temperature 304 is at or above the catalytic threshold 306, the flow diagram 300 may proceed to a keep warm mode 320. In the keep warm mode 320, the process represented in the flow diagram 300 attempts to maintain the catalyst temperature 304 above the catalytic threshold 306 so the SCR process can proceed unabated. For example, in a decrease fuel step 322, the fuel quantity introduced to the plurality of combustion chambers is decreased, for example, to a fueling rate that may be more efficient or operate the internal combustion engine 102 closer to its peak power point. The decrease fuel step 322 results in a decrease in engine speed/exhaust flowrate step 324 as the engine speed slows due to the decrease in fuel quantity per combustion cycle. In diesel combustion engines, this result is due to the engine speed being determined by the quantity of fuel combusted. In an exhaust direction step 326, the decreased exhaust flowrate is directed to the SCR catalyst 152 to maintain the catalyst temperature 304 above the catalytic threshold 306. Because of the lower volume of exhaust flowrate, less enthalpy or heat energy may be transferred per unit time to the SCR catalyst 152. In addition, because of the reduced volume of exhaust flow through the SCR catalyst 152, less heat will be transferred away especially when operating under low load conditions with reduced exhaust temperatures. But because of the rich burn conditions in the internal combustion engine 102, the exhaust flow may be at higher temperatures and may be sufficient to maintain the catalyst temperature 304 above the catalytic threshold 306.

To compensate for the decreased engine speed, the keep warm mode 320 may, in an adjustment step 328 increase the CVT output of the CVT 160. For example, the CVT output speed may be increased relative to the CVT input speed by adjusting the hydrostatic transmission 162 and mechanical transmission 164. In addition, the CVT output torque may be adjusted to maintain the load on the powertrain 100. Accordingly, the overall output of the powertrain 100 remains consistent despite adjustments made to the internal combustion engine 102 and the CVT 160.

Both the warmup 310 mode and the keep warm mode 320 may conduct a NOx reduction step 330 in which the NOx in the exhaust gases is reduced in the SCR catalyst 152 by the SCR process. The flow diagram 300 can also return to the measurement step 302 to continue measuring the catalyst temperature 304 of the SCR catalyst 152 to determine whether switching between warmup and keep warm modes 310, 320 is advantageous at a particular instance. Accordingly, the flow diagram 300 represents a continuing, ongoing process assessing the present operating conditions of the powertrain 100. It should be noted that the flow diagram 300 is exemplary only and that a different order or arrangement of the steps, additional steps, or omission of step is possible. An advantage of the foregoing disclosure is that the internal combustion engine 102 and the CVT 160 can be cooperatively utilized to rapidly heat a SCR catalyst 152 that is below the catalytic threshold and maintain the catalyst temperature when it is above the catalytic threshold. These and other possible advantages and features of the disclosure will be apparent from the foregoing description and accompanying drawings.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

We claim:

1. A drivetrain for a machine comprising:
an internal combustion engine including a plurality of combustion chambers for the combustion of a fuel;
an exhaust system in fluid communication with the plurality of combustion chambers to receive and direct away exhaust gases from the internal combustion engine;
a selective catalytic reduction (SCR) catalyst disposed in the exhaust system to reduce nitrogen oxides (NOx) in the exhaust gases to nitrogen (N₂) and water (H₂O);
a continuously variable transmission operatively (CVT) coupled to a driveshaft of the internal combustion engine; and
an electronic controller operative associated with the internal combustion engine and the CVT and configured to inversely adjust an engine speed and a CVT output to selectively regulate a catalyst temperature of the SCR catalyst.

2. The drivetrain of claim 1, wherein the electronic controller is programmed to implement a warmup mode in which the engine speed is inversely increased compared to the CVT output.

3. The drivetrain of claim 2, wherein the electronic controller is programmed to implement a keep warm mode in which the engine speed is inversely decreased compared to the CVT output.

4. The drivetrain of claim 3, wherein the electronic controller is programmed to shutdown a DEF injector operatively associated with the SCR catalyst during the warmup mode.

5. The drivetrain of claim 1, further comprising a catalyst temperature sensor operatively disposed to measure the catalyst temperature and in communication with the electronic controller.

6. The drivetrain of claim 1, further comprising an engine speed sensor operatively associated with the internal combustion engine to measure the engine speed.

7. The drivetrain of claim 1, wherein the CVT is a hydro-mechanical transmission including a hydrostatic transmission and a mechanical transmission.

8. The drivetrain of claim 7, wherein the hydro-mechanical transmission is a split torque transmission simultaneously directing torque to the hydrostatic transmission and the mechanical transmission.

9. The drivetrain of claim 8, wherein the hydrostatic transmission includes a variable pump and variable motor in fluid communication through a fluid circuit.

10. The drivetrain of claim 8, wherein the mechanical transmission includes a plurality of intermeshing gears.

11. The drivetrain of claim 10, wherein the mechanical transmission includes a planetary gear.

12. A method of operating a powertrain to regulate temperature of a selective catalytic reduction (SCR) catalyst comprising:
measuring a catalyst temperature of an SCR catalyst disposed in an exhaust system operatively associated with an internal combustion engine;
regulating an engine speed of the internal combustion engine in an inverse relation to the catalyst temperature; and
regulating a CVT output of a continuously variable transmission (CVT) operatively coupled to the internal combustion engine in a direct relation to the catalyst temperature.

13. The method of claim 12, further involving directing exhaust gases from the internal combustion engine to the CVT and reducing nitrogen oxides (NOₓ) in the exhaust gases to nitrogen (N₂) and water (H₂O) in the SCR catalyst.

14. The method of claim 13, further involving adjusting a fuel injection quantity to the internal combustion engine to regulating the engine output speed.

15. The method of claim 13, further comprising:
comparing the catalyst temperature to a catalytic threshold; and
regulating the engine speed and CVT output based on the comparison.

16. The method of claim 15, wherein the step of regulating the engine speed increases the engine speed and decreases the CVT output if the catalyst temperature is lower than the catalytic threshold.

17. The method of claim 16, wherein the step of regulating the engine speed decreases the engine speed and increases the CVT output if the catalyst temperature is lower than the catalytic threshold.

18. A powertrain for a machine comprising:
an internal combustion engine including a plurality of combustion chambers for the combustion of a fuel;
an exhaust system in fluid communication with the plurality of combustion chambers to receive and direct away exhaust gases from the internal combustion engine;
a selective catalytic reduction (SCR) catalyst disposed in the exhaust system to reduce nitrogen oxides (NOₓ) in the exhaust gases to nitrogen (N₂) and water (H₂O);
a continuously variable transmission operatively (CVT) coupled to a driveshaft of the internal combustion engine; and
an electronic controller operative associated with the internal combustion engine and the CVT and configured receive and compare the catalyst temperature to the catalytic threshold, the electronic controller further configured to increase an engine speed and restrict a CVT output if the catalyst temperature is below the catalytic threshold.

19. The powertrain of claim 18, wherein the electronic controller is further configured to decrease the engine speed and increase the CVT output if the catalyst temperature is above the catalytic threshold.

20. The powertrain of claim 20, wherein the CVT is a hydro-mechanical transmission including a hydrostatic transmission and a mechanical transmission.
